(19) United States
(12) Patent Application Publication
(10) Pub. No.: US 2025/0077936 A1
(43) Pub. Date: Mar. 6, 2025

(54) RENDERING ENTITIES IN DIGITAL TWINS

(71) Applicant: International Business Machines Corporation, Armonk, NY (US)

(72) Inventors: Peng Hui Jiang, Beijing (CN); Jun Su, Beijing (CN); WEN YI GAO, Beijing (CN); Jia Tian Zhong, Beijing (CN); Dong Hui Liu, Beijing (CN); Jia Yu, Beijing (CN); Di Li Hu, Beijing (CN)

(21) Appl. No.: 18/239,262

(22) Filed: Aug. 29, 2023

(51) Int. Cl. G06N 20/00

(52) U.S. Cl. CPC G06N 20/00

(57) ABSTRACT

Rendering digital twin include receiving metrics associated with a physical entity, the metrics received using an established real-time data synchronization protocol. The received metrics is analyzed. Based on the analysis of the received metrics, digital twin corresponding to the physical entity is updated, the digital twin being a virtual representation of the physical entity.

### BACKGROUND

The present application relates generally to computers and computer applications, and more particularly to rendering entities in digital twins.

### BRIEF SUMMARY

The summary of the disclosure is given to aid understanding of a computer system and method of rendering entities in digital twins, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A computer-implemented method, in some embodiments, includes receiving metrics associated with a physical entity, the metrics received using an established real-time data synchronization protocol. The computer-implemented method also includes analyzing the received metrics. The computer-implemented method further includes, based on the analysis of the received metrics, updating digital twin corresponding to the physical entity, the digital twin being a virtual representation of the physical entity.

A system, in some embodiment, includes at least one computer processor. The system also includes at least one memory device coupled with the at least one computer processor. The at least one computer processor is configured to receive metrics associated with a physical entity, the metrics received using an established real-time data synchronization protocol. The at least one computer processor is also configured to analyze the received metrics. The at least one computer processor is also configured to, based on analysis of the received metrics, update digital twin corresponding to the physical entity, the digital twin being a virtual representation of the physical entity.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement rendering entities in digital twins in an embodiment.

FIG. 2 is a diagram illustrating system architecture for digital twin rendering in some embodiments.

FIG. 3 shows data synchronization between a real-world physical entity and a digital twin in some embodiments.

FIG. 4 is a diagram illustrating real-time data streaming in some embodiments.

FIG. 5 is a diagram illustrating publisher-subscriber scheme in digital twin rendering in some embodiments.

FIG. 6 is a diagram illustrating data processing and adaptation in some embodiments.

FIG. 7 shows an example transformation graphically in some embodiments.

FIG. 8 is a diagram showing data interpolation and extrapolation in some embodiments.

FIG. 9 shows an example calculation using cubic spline interpolation in some embodiments.

FIG. 10 shows an example time series prediction plot in some embodiments.

FIG. 11 shows an example of real-world data, which can contain noise in some embodiments.

FIG. 12 is a flow diagram illustrating a digital twin rendering workflow in some embodiments.

FIG. 13 is a flow diagram illustrating a digital twin rendering method in some embodiments.

FIG. 14 is a diagram showing components of a system in some embodiments that can render digital twins.

### DETAILED DESCRIPTION

A computer-implemented method, in some embodiments, includes receiving metrics associated with a physical entity, the metrics received using an established real-time data synchronization protocol. The computer-implemented method also includes analyzing the received metrics. The computer-implemented method further include, based on the analysis of the received metrics, updating digital twin corresponding to the physical entity, the digital twin being a virtual representation of the physical entity. The digital twin is a virtual representation of the physical entity. In some aspects, more accurate digital twin rendering can be provided by utilizing one or more synchronization protocols, real-time streaming, data analysis and modeling.

One or more of the following features can be separable or optional from each other. In some embodiments, the metrics include data generated by at least one of sensors, devices and databases associated with the physical entity. The data captures information about the physical entity. For instance, information about the physical entity can be received by way of data detected by one or more sensors and/or devices associated with the physical entity, and/or by way of data stored on one or more databases associated with the physical entity.

In some embodiments, the real-time data synchronization protocol includes publish-subscribe protocol established between the physical entity and the digital twin. For instance, the physical entity can act as a publisher and the digital twin can act as a subscriber, where the physical entity publishes its data, and the digital twin subscribes to the physical entity's data.

In some embodiments, the analysis includes analyzing trends of data change in the received metrics, and based on the trends of data change, dynamically adjusting an interval of data streaming received from the physical entity. In this way, for example, the frequency of receipt of data at the digital twin can be dynamically adjusted, thereby providing efficiency in data collection.

In some embodiments, the analysis includes estimating data to fill missing data points in the received metrics, and where the digital twin is updated using the estimated data. Smooth visual updates can be maintained even in the presence of potential data delay or network latency.

In some embodiments, the analysis includes predicting future data points based on historical trends and available data, and where the digital twin is updated using the predicted future data points. Smooth visual updates can be maintained even in the presence of potential data delay or network latency.

In some embodiments, the updating of the digital twin includes rendering visual updates to the digital twin. Physical entities can be rendered as a virtual visual representation.

A system including at least one computer processor and at least one memory device coupled with the at least one computer processor is also disclosed, where the at least one computer processor is configured to perform one or more methods described above. A computer program product is also disclosed that includes a computer readable storage medium having program instructions embodied therewith, where the program instructions are readable by a device to cause the device to perform one or more methods described above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as digital twin rendering algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

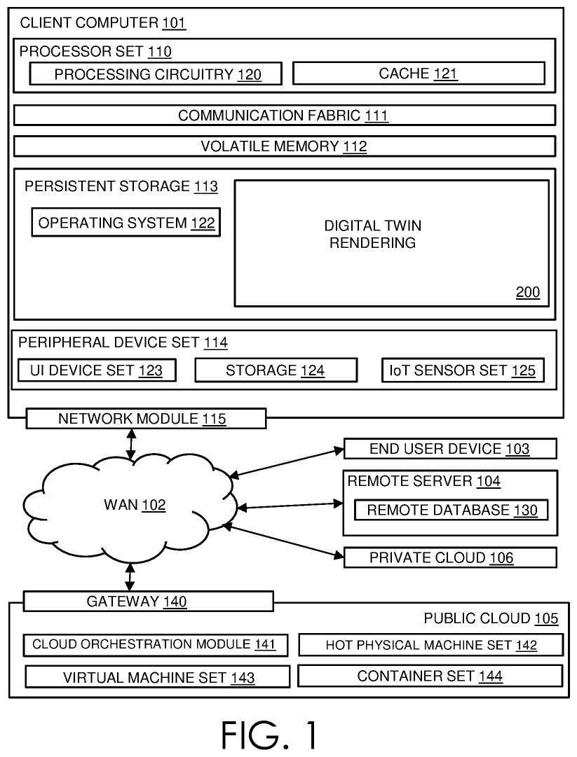

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101.

Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102.

Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A digital twin is a virtual representation of an object or system that spans its lifecycle, and is updated from real-time data. A digital twin uses simulation, machine learning and reasoning to help decision making. For example, a digital twin is a virtual model designed to accurately reflect a physical object. The object being studied—for example, a wind turbine—is outfitted with various sensors related to areas of functionality. These sensors produce data about different aspects of the physical object's performance, such as energy output, temperature, weather conditions and more. This data is then relayed to a processing system and applied to the digital copy. Once informed with such data, the virtual model can be used to run simulations, study performance issues and generate possible improvements, which can generate valuable insights, which can then be applied back to the original physical object. Uses or applications of digital twins can include, but are not limited to, power-generation equipment, physical structures, manufacturing operations, healthcare services, automotive industry and urban planning.

By rendering an entity in a digital twin, a visual representation can be created of the physical assets or systems being simulated or monitored. Efficiently rendering multiple entities in real-time while maintaining high performance and scalability, ensuring synchronized representation of entities with real-world counterparts in real-time, capturing data streams, accurately updating rendered entities in a timely manner, and handling interactions between entities and detecting collisions in real-time, considering factors like geometry, velocity, and physics-based interactions, can be challenging, especially with updates that involve complex geometries and dynamicity.

In some embodiments, systems, methods and/or techniques are disclosed that provide rendering of a digital twin that utilize synchronization protocols, real-time streaming, data analysis and modeling. In some embodiments, the systems, methods and/or techniques establish data synchronization protocols to capture real-time updates from the physical environment and reflect them in the digital twin, utilize real-time data streaming to transmit and process data in a timely manner, analyze data change trend and dynamically adjust interval of data streaming, use a publisher-subscriber pattern to enable timely updates and synchronization between entities in the digital twin, use data interpolation and extrapolation models to smooth out data updates and handle potential latency issues, apply interpolation to estimate missing or delayed data points between received updates and render them in digital twin, e.g., utilize extrapolation algorithms to predict future data points based on historical trends and available data and maintain smooth visual updates even in the presence of potential data delays or network latency, and/or verify the correctness and accuracy of interpolation and extrapolation models and adjust the models to react the changes of physical entities.

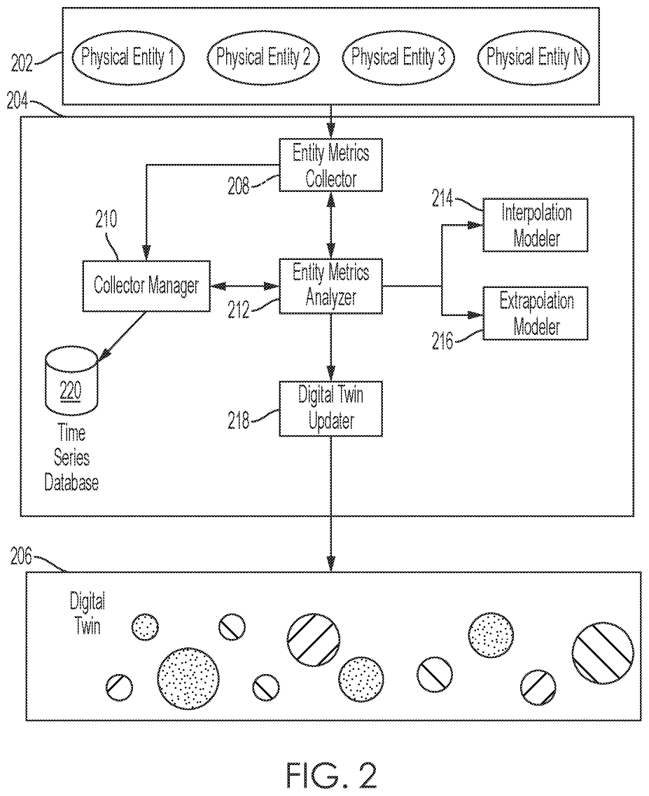

FIG. 2 is a diagram illustrating system architecture for digital twin rendering in some embodiments. At 202, real world physical entities are shown. As described above, physical entities can be physical equipment, building structure, information system data center structure, and/or others. Digital twin rendering can be performed by or using the components shown at 204, which are computer-implemented components such as program functions, instructions, and/or modules. Digital twin rendering at 204 produces or outputs digital twins 206.

Referring to 204, entity metrics collector 208 utilizes a data real-time streaming framework that supports high-throughput, low-latency data transmission between physical world and digital twin. Data may be transmitted from or received from various sensors, devices, or databases associated with the physical entities 202.

Entity metrics manager 210 manages time series database 220 and generates input to entity metrics analyzer 212.

Entity metrics analyzer 212 uses a data processing engine or stream processing framework to handle incoming data streams, performs real-time analysis, and applies necessary transformations or calculations such as interpolation and extrapolation. For instance, interpolation modeler or model 214 performs interpolation to generate any missing data between collected intervals. For example, interpolation modeler or model 214 applies one or more interpolation algorithms to estimate missing or delayed data points between received updates. Extrapolation modeler or model 216 performs data extrapolation based on prior collected data. Extrapolation modeler or model 216 utilizes one or more extrapolation algorithms to predict future data points based on historical trends and available data. Such extrapolation can help in maintaining smooth visual updates even in the presence of potential data delays or network latency. Interpolation model 214 and extrapolation model 216 can be a regression model and/or another machine learning model such as a neural network model. The analyzer also detects the metrics trend of physical entities 202 and adjusts the collection interval dynamically.

Digital twin updater 218 ensures accurate time synchronization across different components of digital twin rendering at 204 using different protocols, and also facilitates real-time communication and synchronization between different components at 204.

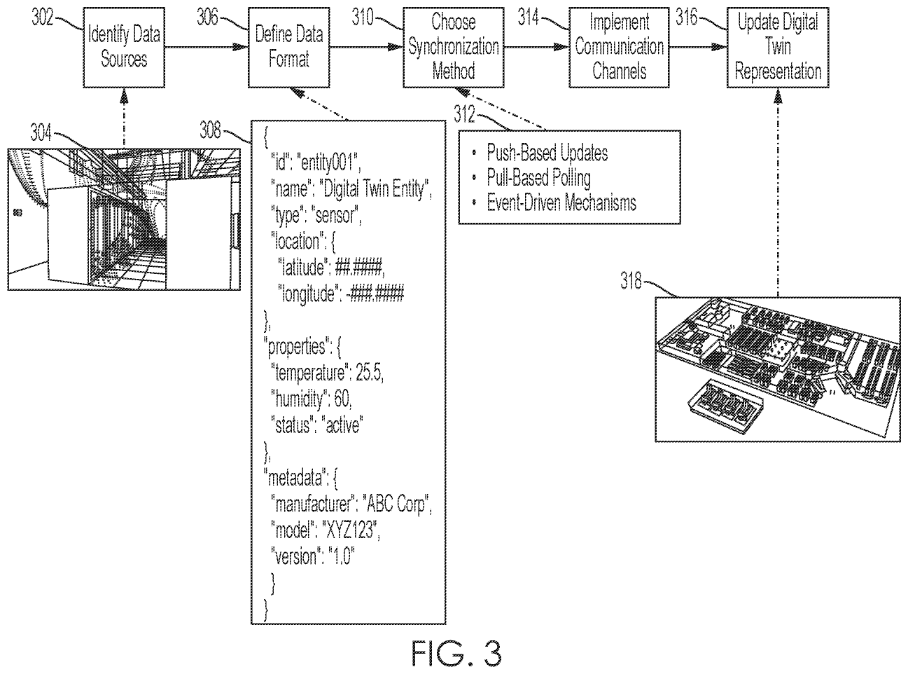

FIG. 3 shows data synchronization between a real world physical entity and a digital twin in some embodiments. One or more computer processors and/or hardware processors can perform such data synchronization. For example, data synchronization protocols can be established to capture real-time updates from the physical environment and to reflect the captured data or information in the digital twin. At 302, data sources are identified. An example of data sources is a data center 304. For example, information or sensor data pertaining to a physical data center can be captured. At 306, data format can be defined that store captured data or information. An example data format is shown at 308. Examples of information captured about the physical data center can include, but are not limited to, location data, physical environment data such as temperature, humidity, as well as the current status such as whether the data center is active, additional metadata such as manufacturer, model and version information about the equipment stored in the data center, and/or others.

At 310, synchronization method or scheme is selected. For example, shown at 312, a synchronization can be done based on push-based updates, pull-based polling, and/or event-driven scheme. For instance, in push-based updates, the data sources push or transmit information, e.g., periodically or upon availability of data. In pull-based polling, a receiver of data polls or requests data updates, e.g., periodically. In event-driven scheme, data can be received from the data sources upon an occurrence of an event. The type of event that triggers the data update can be pre-configured or pre-defined, e.g., given.

At 314, communication channels between the data sources and digital twin rendering (e.g., shown at 204) can be implemented. For example, in some embodiments, communication channels between data sources and digital twin rendering encompass wired and wireless technologies like Ethernet, wireless network protocol (Wi-Fi), and Message Queuing Telemetry Transport (MQTT), enabling real-time data transmission and interaction, while security measures such as encryption and authentication ensure data privacy and integrity. Middleware, cloud services, and edge computing act as intermediaries, facilitating seamless data exchange for maintaining an accurate and responsive virtual representation of physical entities.

At 316, digital twin representation can be updated. For instance, virtual representation of the data center 304 can be implemented on a digital computer 318 and the virtual representation updated according to the established synchronization.

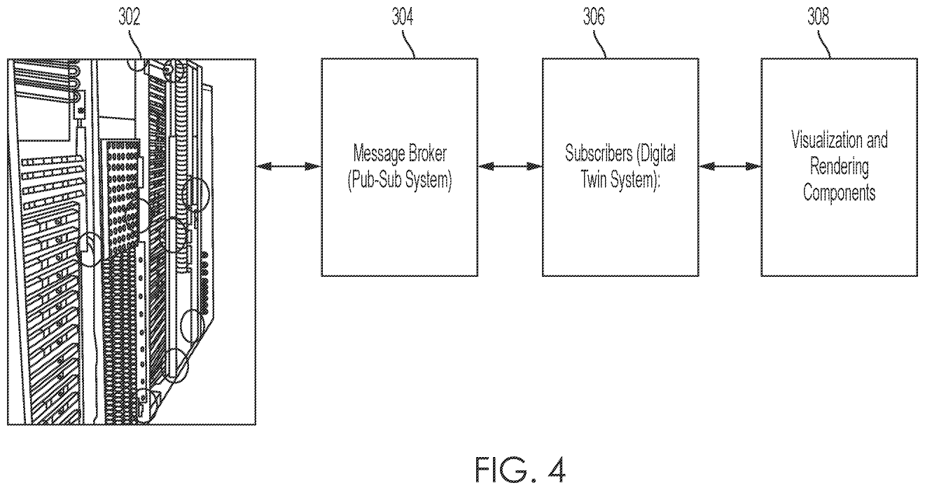

FIG. 4 is a diagram illustrating real-time data streaming in some embodiments. Digital rendering framework in some embodiments utilizes real-time data streaming to transmit (and/or receive) and process data in a timely manner. For example, a message broker such as a publisher-subscriber system 404 manages data transmission/receipt between data sources of a physical environment 402, e.g., sensors of a data center, and digital twin rendering module 406 (e.g., 204 in FIG. 2). Visualization and rendering components 408 render visualization of the physical environment, e.g., data center, e.g., a virtual representation of the data center, based on the data transmitted from the real physical data center 402. In some embodiments, visualization and rendering components 408 can be part of the digital twin rendering module 406, or a separate component that can render computer graphical visualization based on updated data.

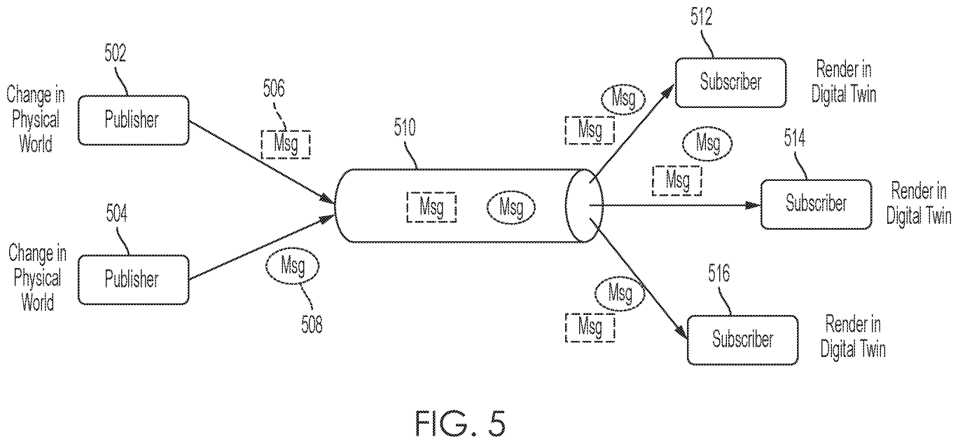

FIG. 5 is a diagram illustrating publisher-subscriber scheme in digital twin rendering in some embodiments. Publishers 502, 504 can be sensors associated with physical environment, where based on changes in physical world, data is transmitted as messages 506, 508 to a queue or storage 510. The queued or stored messages are transmitted to (or received at/by) subscribers of the data 512, 514, 516, for example, digital twin rendering modules.

Publish-subscribe protocol is implemented for efficient and asynchronous data communication between different components of the digital twin rendering system. Data streaming framework utilizes a robust and efficient data streaming framework or middleware that supports high-throughput, low-latency data transmission.

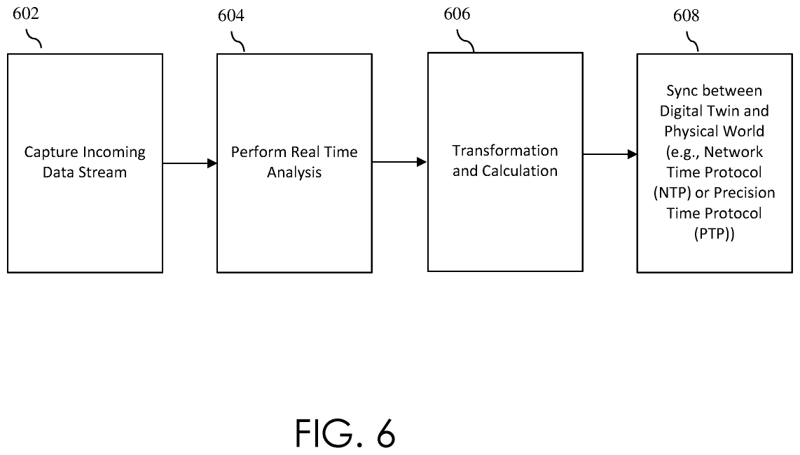

FIG. 6 is a diagram illustrating data processing and adaptation in some embodiments. At 602, a data processing engine handles incoming data streams. At 604, real-time analysis is performed. At 606, transformations or calculations are applied. At 608, accurate time synchronization is ensured across different digital twin rendering components using protocols like Network Time Protocol (NTP) and/or Precision Time Protocol (PTP).

For example, real-time analysis at 604 includes analyzing data change/update trend and extracting phase of metric waveform as follows.

A computer processor applies a Fourier transform to time series data.

$$E . g . : ( {x}_{0} , ... , {x}_{N - 1} ) \to ( {y}_{0} , ... , {y}_{N - 1} ) , \\ where {y}_{k} = \frac{1}{\sqrt{N}} {\sum }_{j = 0}^{N - 1} {x}_{j} {w}_{N}^{jk} , {w}_{N}^{jk} = {e}^{2 π i \frac{jk}{N}}$$

Fourier [x(t)]=a₀+Eₙ₌₁^{∞}(aₙ cos(nwt)+bₙ sin(nwt)), where Fourier represents the Fourier transform operator, and x(t) represents the time series respectively.
The computer processor also computes the magnitude and phase spectrum from the Fourier transform as follows:

$$M ( f ) = \vert {a}_{0} + {\sum }_{n = 1}^{∞} ( {a}_{n} cos ( nwt ) + {b}_{n} sin ( nwt ) ) \vert$$

$$Φ ( f ) = arg ( {a}_{0} + {\sum }_{n = 1}^{∞} ( {a}_{n} cos ( nwt ) + {b}_{n} sin ( nwt ) ) )$$

M(f) and Φ(f) represent the magnitude and phase spectra respectively.
The computer processor also extracts the phase component from the phase spectrum, which represents the phase series.

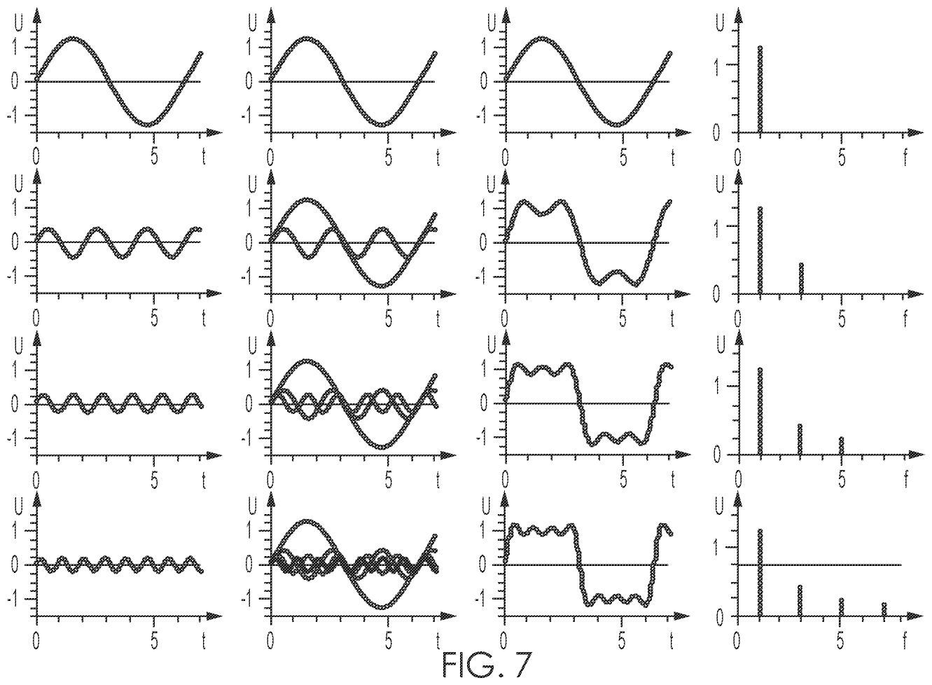

Applying transformation at 606 can include dynamically adjusting interval of data streaming based on the analysis performed at 604. FIG. 7 shows an example transformation graphically in some embodiments. In some embodiments, “Fourier Encoding,” also known as “Fourier Transform,” is used to analyze and represent input data in terms of their frequency components. It can break down an input into a sum of sinusoidal components, revealing the frequencies present in the input data. FIG. 7 represents “Waveform Overlay” of combining multiple waveforms together. Multiple different waveforms are shown in the rows (e.g., from top to bottom). The columns across the rows (e.g., from left to right) show the result of waveform overlay. The overlaying waveforms can add or superimpose individual sine and cosine waves, each representing a different frequency component of a complex input data. The transformation from the time domain to the frequency domain is represented in the last column by applying the Fourier Transform to an input data. In the time domain, an input data is represented as a function of time, showing how the input data varies over time. When transformed to the frequency domain using Fourier Encoding, the input data is represented as a sum of sinusoidal waves with different frequencies, revealing the distinct frequency components that make up the original input data.

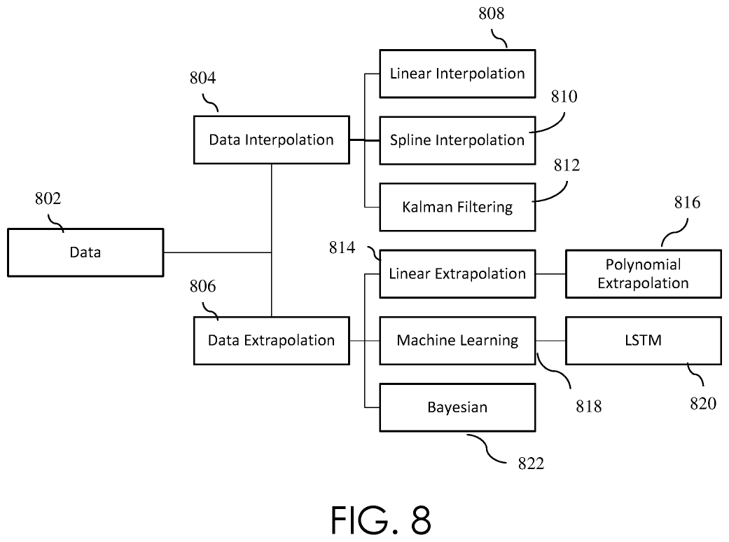

FIG. 8 is a diagram showing data interpolation and extrapolation in some embodiments. Data interpolation 804 includes applying one or more interpolation algorithms to estimate missing or delayed data points between received updates 802. Examples of interpolation algorithms includes linear interpolation 808, spline interpolation 810 and Kalman filtering 812. Data extrapolation 806 includes utilizing one or more extrapolation algorithms to predict future data points based on historical trends and available data 802. Examples of extrapolation algorithms include linear extrapolation 814, which can also include polynomial extrapolation 816, machine learning 818, which can be long short-term memory (LSTM) 820, and Bayesian algorithm 822. Other interpolation and extrapolation algorithms can be used. Data interpolation and/or extrapolation can help in maintaining smooth visual updates even in the presence of potential data delays or network latency.

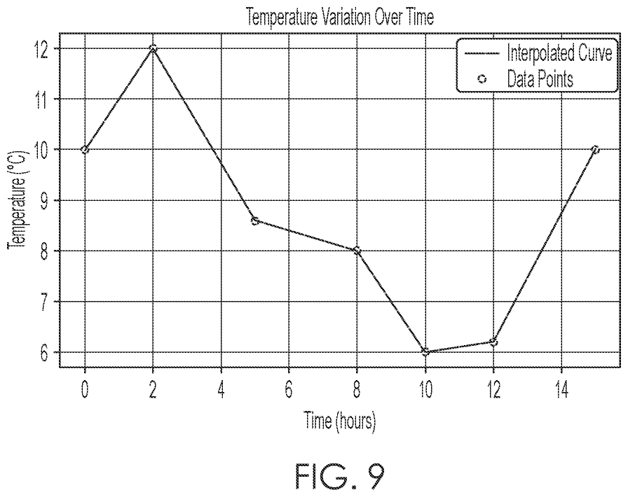

Interpolation estimates the value of missing data points using a different line between adjacent data points. In some embodiments, interpolation assumes a linear or curve change between data points, resulting in a smooth curve. By way of example, consider the temperature data received from one or more sensors of data source shown in Table 1. Temperature data at time unit 5 and 12 are missing. Those missing data can be interpolated, for example, by fitting a curve to the available data points, and also considering the neighboring points and ensuring smoothness. For instance, the calculation using cubic spline interpolation is shown in FIG. 9. Estimated temperature at time unit 5 is a spline interpolation result, which is 8.6 degrees Celsius. Estimated temperature at time unit 12 is spine interpolation result, which is 6.2 degrees Celsius.

TABLE 1

| Time (hours) | Temperature (degrees Celsius) (° C.) |
|---|---|
| 0 | 10 |
| 2 | 12 |
| 5 | — |
| 8 | 8 |
| 10 | 6 |
| 12 | — |
| 15 | 10 |

Extrapolation estimates values beyond the known data range by extending the existing trend or pattern. The values can be predicted by assuming that the relationship observed within the data continues outside the available range. An example extrapolation calculation is as follows:

Rate of change=(Temperature at hour 19−Temperature at hour 18)/(Hour 19−Hour 18).

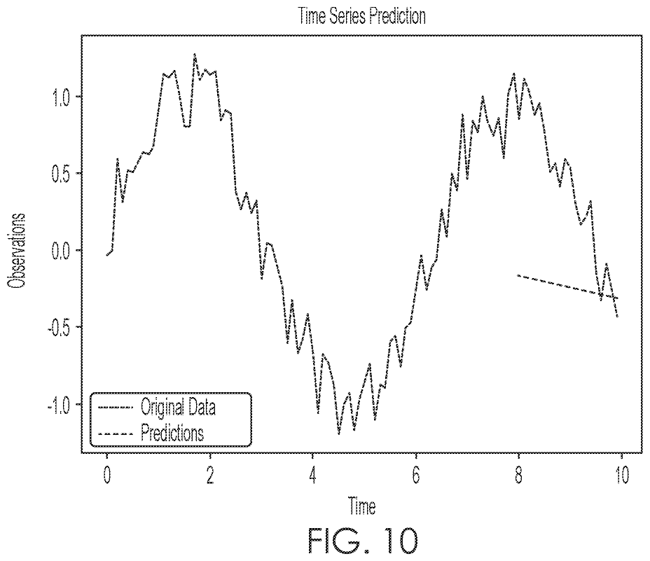

Using the example data points shown in Table 2, Rate of change=(30/31)/(19−18)=−1. Note that (Hour 19−Hour 18) denotes time unit difference. Using this rate of change, one can estimate the temperatures for the missing future time periods by extending the linear trend as follows: Estimated Temperature at hour 20=Temperature at hour 19+(Rate of change*(Hour 20−Hour 19)). Using the example data points shown in Table 2, estimated temperature at hour 20=30+(−1*(20−19))=29 degrees Celsius (° C.). FIG. 10 shows an example time series prediction plot in some embodiments.

TABLE 2

| Time (hours) | Temperature (degrees Celsius) |
|---|---|
| 0 | 25 |
| 1 | 26 |
| 2 | 27 |
| . . . | . . . |
| 18 | 31 |
| 19 | 30 |
| 20 | ? |
| 21 | ? |
| 22 | ? |
| . . . | . . . |
| 40 | ? |

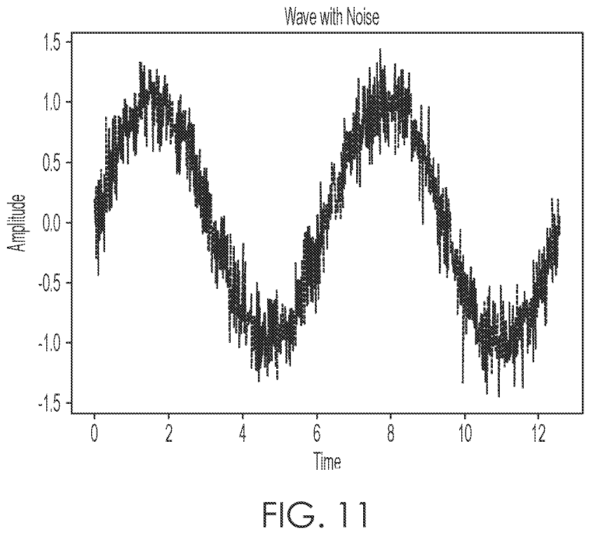

Real-world data used to create digital twins can be noisy, incomplete, or subject to various uncertainties. A system and/or method for digital twin rendering in some embodiments handles and processes such complex data to generate a reliable and accurate representation of the physical system. FIG. 11 shows an example of real-world data, which can contain noise in some embodiments. For example, digital twin rendering in some embodiments preprocesses the received data to remove some of the spikes (noise) shown in the curve. One or more rules can be established to filter noise. For instance, data points outside of predefined thresholds can be filtered.

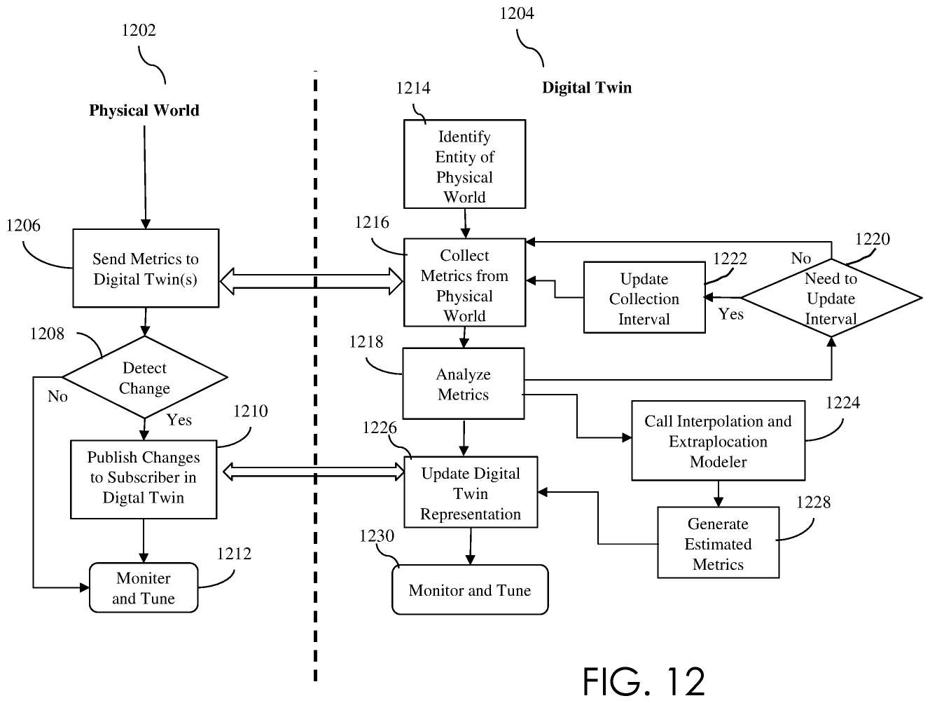

FIG. 12 is a flow diagram illustrating a digital twin rendering workflow in some embodiments. The workflow in some embodiments includes interaction between one or more physical entities in physical world 1202 and one or more digital twins 1204. As described above, by way of example, one or more physical entities include a data center, and one or more digital twins include a virtual representation of that data center. In the physical world, data sensors or devices such as edge devices associated with data sensors can transmit data. For instance, at 1206, metrics about the physical world is transmitted to digital twin, e.g., a component involved in rendering digital twin. At 1208, a computer processor operating in the physical world 1202 detects changes to the metrics. If changes to metrics are detected, at 1210, the computer process publishes the changes, such that a subscriber (e.g., a component of digital twin rendering) can receive data or metric updates. If no changes are detected at 1208, processing proceeds to 1212.

At 1212, monitoring and tuning of one or more physical entities can continue.

On digital twin 1204 side (e.g., components involved in rendering digital twin), at 1214, one or more processors (e.g., one or more computer processors) identifies one or more entities of physical world, e.g., a data center. At 1216, one or more processors collect metrics from physical world 1202 (e.g., one or more computer processors operating in conjunction with one or more physical entities in physical world). At 1218, one or more processors analyze the received metrics. Analyzing the metrics includes determining whether a data collection interval should be updated. For instance, an analysis determines based on the data pattern over time (e.g., time series data), whether the data should be collected more frequently or less frequently. For example, metrics that exhibit frequent changes may be collected more frequently. On the other hand, metrics that exhibit less changes over periods of time may be collected less frequently. For instance, volatility of metrics over time may determine time intervals over which data should be collected. In some embodiments, such analysis can be performed using Fourier transform described above. In some embodiments, the time interval changes dynamically, for example, continuously based on continuous analysis that is performed.

At 1220, if it is determined that the interval of collection should be updated, at 1222, the collection interval is updated. If no update to the collection interval is needed, processing proceeds to 1216, where metric collection continues.

Analyzing metrics at 1218 may also include interpolating and/or extrapolating the metrics data at 1224. For example, if the analysis identifies that a data point is missing, an interpolation modeler that performs interpolation can be invoked to supply the missing data. As another example, an extrapolation modeler can be invoked to predict future values corresponding to future time. At 1228, interpolation and/or extrapolation produces estimated metrics, e.g., interpolated missing data and/or extrapolated predicted future data.

At 1226, based on the estimated metrics, digital twin representation can be updated. For example, a display of digital twin representation can be updated using the estimated metrics. At 1230, monitoring and tuning continues, to overall health and maintenance of digital twin.

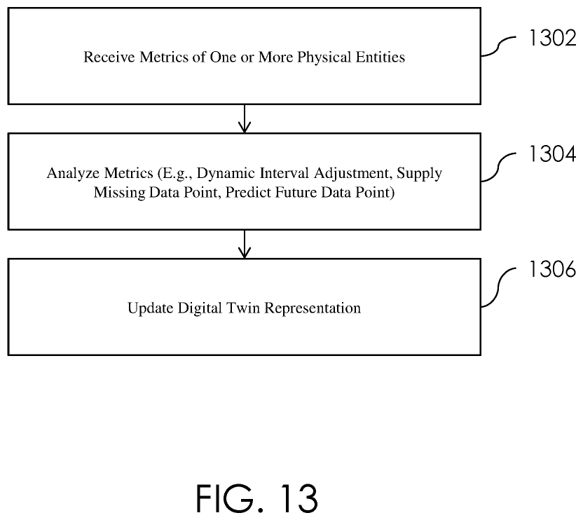

FIG. 13 is a flow diagram illustrating a digital twin rendering method in some embodiments. One or more computer processors, e.g., hardware processor can implement the method. At 1302, the method includes receiving metrics associated with a physical entity. The metrics are received using an established real-time data synchronization protocol, for example, as described above. At 1304, the method includes analyzing the received metrics. At 1306, the method includes, based on the analysis of the received metrics, updating digital twin corresponding to the physical entity. As described above, the digital twin is a virtual representation of the physical entity. In some aspects, more accurate digital twin rendering can be provided by utilizing one or more synchronization protocols, real-time streaming, data analysis and modeling.

One or more of the following features can be separable or optional from each other. In some embodiments, the metrics include data generated by at least one of sensors, devices and databases associated with the physical entity. The data captures information about the physical entity. For instance, information about the physical entity can be received by way of data detected by one or more sensors and/or devices associated with the physical entity, and/or by way of data stored on one or more databases associated with the physical entity.

In some embodiments, the real-time data synchronization protocol includes publish-subscribe protocol established between the physical entity and the digital twin. For instance, the physical entity can act as a publisher and the digital twin can act as a subscriber, where the physical entity publishes its data, and the digital twin subscribes to the physical entity's data.

In some embodiments, the analysis includes analyzing trends of data change in the received metrics, and based on the trends of data change, dynamically adjusting an interval of data streaming received from the physical entity. In this way, for example, the frequency of receipt of data at the digital twin can be dynamically adjusted, thereby providing efficiency in data collection.

In some embodiments, the analysis includes estimating data to fill missing data points in the received metrics, and where the digital twin is updated using the estimated data. Smooth visual updates can be maintained even in the presence of potential data delay or network latency.

In some embodiments, the analysis includes predicting future data points based on historical trends and available data, and where the digital twin is updated using the predicted future data points. Smooth visual updates can be maintained even in the presence of potential data delay or network latency.

In some embodiments, the updating of the digital twin includes rendering visual updates to the digital twin. Physical entities can be rendered as a virtual visual representation.

A system including at least one computer processor and at least one memory device coupled with the at least one computer processor is also disclosed, where the at least one computer processor is configured to perform one or more methods described above. A computer program product is also disclosed that includes a computer readable storage medium having program instructions embodied therewith, where the program instructions are readable by a device to cause the device to perform one or more methods described above.

In some embodiments, systems and methods establish data synchronization protocols to capture real-time updates from the physical environment and reflect them in the digital twin. In some embodiments, systems and/or methods use publisher-subscriber pattern to enable timely updates and synchronization between entities in the digital twin. In some embodiments, systems and/or methods use data interpolation and extrapolation models to smooth out data updates and handle potential latency issues. In some embodiments, systems and/or methods, utilize extrapolation algorithms to predict future data points based on historical trends and available data and maintain smooth visual updates even in the presence of potential data delays or network latency. In some embodiments, systems and/or methods verify correctness and accuracy of interpolation and extrapolation models and adjust the models to react to the changes of physical entities.

In some embodiments, systems and methods provide rendering in digital twins by utilizing synchronization protocols, real-time streaming, data analysis and modeling. These features can ensure accuracy and usability of digital twin market. For example, using publisher-subscriber pattern allows for smooth estimation of missing data points between known data points. By filling in the gaps, the digital twin can provide a more complete and continuous representation of the system being modeled. Using data interpolation and extrapolation models allows the digital twin to provide insights and forecasts for upcoming time periods, facilitating proactive decision-making. By verifying correctness and accuracy of interpolation and extrapolation models, accuracy and computational efficiency can be balanced, and the performance and scalability of the digital twin can be improved.

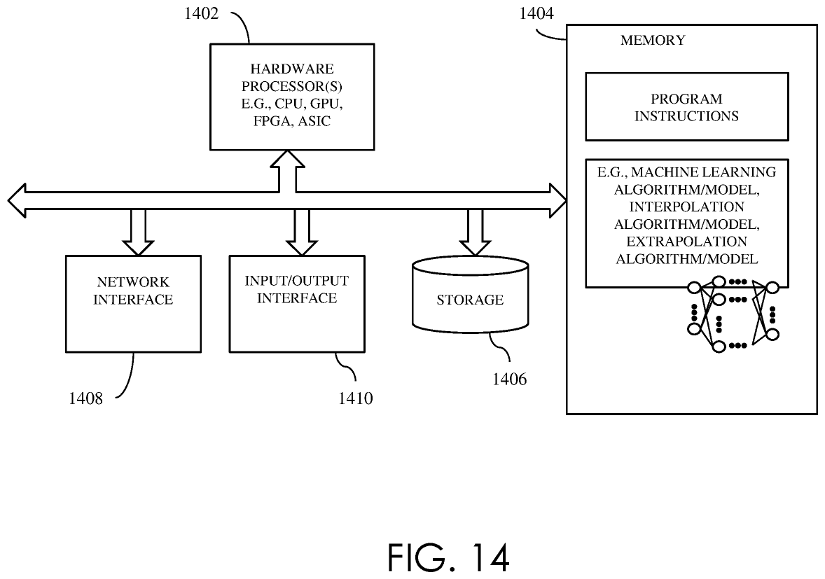

FIG. 14 is a diagram showing components of a system in some embodiments that can render digital twins. FIG. 14 is a diagram showing components of a system in some embodiments that can render digital twins. One or more hardware processors 1402 such as a central processing unit (CPU), a graphic process unit (GPU), and/or a Field Programmable Gate Array (FPGA), an application specific integrated circuit (ASIC), and/or another processor, may be coupled with a memory device 1404, and render digital twins. A memory device 1404 may include random access memory (RAM), read-only memory (ROM) or another memory device, and may store data and/or processor instructions for implementing various functionalities associated with the methods and/or systems described herein. One or more processors 1402 may execute computer instructions stored in memory 1404 or received from another computer device or medium. A memory device 1404 may, for example, store instructions and/or data for functioning of one or more hardware processors 1402, and may include an operating system and other program of instructions and/or data. One or more hardware processors 1402 may receive metrics associated with a physical entity. The metrics may be received using an established real-time data synchronization protocol. One or more hardware processors 1402 may also analyze the received metrics. One or more hardware processors 1402 may also, based on analysis of the received metrics, update digital twin corresponding to the physical entity. The digital twin is a virtual representation of the physical entity. In some aspects, data may be stored in a storage device 1406 or received via a network interface 1408 from a remote device, and may be temporarily loaded into a memory device 1404 for functioning of the digital twin rendering. One or more hardware processors 1402 may be coupled with interface devices such as a network interface 1408 for communicating with remote systems, for example, via a network, and an input/output interface 1410 for communicating with input and/or output devices such as a keyboard, mouse, display, and/or others.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving metrics associated with a physical entity, the metrics received using an established real-time data synchronization protocol;
analyzing the received metrics; and
based on the analysis of the received metrics, updating digital twin corresponding to the physical entity, the digital twin being a virtual representation of the physical entity.

2. The computer-implemented method of claim 1, wherein the metrics include data generated by at least one of sensors, devices and databases associated with the physical entity, the data capturing information about the physical entity.

3. The computer-implemented method of claim 1, wherein the real-time data synchronization protocol includes publish-subscribe protocol established between the physical entity and the digital twin.

4. The computer-implemented method of claim 1, wherein the analysis includes analyzing trends of data change in the received metrics, and based on the trends of data change, dynamically adjusting an interval of data streaming received from the physical entity.

5. The computer-implemented method of claim 1, wherein the analysis includes estimating data to fill missing data points in the received metrics, and wherein the digital twin is updated using the estimated data.

6. The computer-implemented method of claim 1, wherein the analysis includes predicting future data points based on historical trends and available data, and wherein the digital twin is updated using the predicted future data points.

7. The computer-implemented method of claim 1, wherein the updating the digital twin includes rendering visual updates to the digital twin.

8. A computer program product comprising a computer readable storage medium having program instructions embodied therewith, the program instructions readable by a device to cause the device to:
receive metrics associated with a physical entity, the metrics received using an established real-time data synchronization protocol;
analyze the received metrics; and
based on analysis of the received metrics, update digital twin corresponding to the physical entity, the digital twin being a virtual representation of the physical entity.

9. The computer program product of claim 8, wherein the metrics include data generated by at least one of sensors, devices and databases associated with the physical entity, the data capturing information about the physical entity.

10. The computer program product of claim 8, wherein the real-time data synchronization protocol includes publish-subscribe protocol established between the physical entity and the digital twin.

11. The computer program product of claim 8, wherein the analysis includes analyzing trends of data change in the received metrics, and based on the trends of data change, dynamically adjusting an interval of data streaming received from the physical entity.

12. The computer program product of claim 8, wherein the analysis includes estimating data to fill missing data points in the received metrics, and wherein the digital twin is updated using the estimated data.

13. The computer program product of claim 8, wherein the analysis includes predicting future data points based on historical trends and available data, and wherein the digital twin is updated using the predicted future data points.

14. The computer program product of claim 8, wherein the device is caused to update the digital twin by rendering visual updates to the digital twin.

15. A system comprising:
at least one computer processor;
at least one memory device coupled with the at least one computer processor;
the at least one computer processor configured to at least:
receive metrics associated with a physical entity, the metrics received using an established real-time data synchronization protocol;
analyze the received metrics; and
based on analysis of the received metrics, update digital twin corresponding to the physical entity, the digital twin being a virtual representation of the physical entity.

16. The system of claim 15, wherein the metrics include data generated by at least one of sensors, devices and databases associated with the physical entity, the data capturing information about the physical entity.

17. The system of claim 15, wherein the real-time data synchronization protocol includes publish-subscribe protocol established between the physical entity and the digital twin.

18. The system of claim 15, wherein the analysis includes analyzing trends of data change in the received metrics, and based on the trends of data change, dynamically adjusting an interval of data streaming received from the physical entity.

19. The system of claim 15, wherein the analysis includes estimating data to fill missing data points in the received metrics, and wherein the digital twin is updated using the estimated data.

20. The system of claim 15, wherein the analysis includes predicting future data points based on historical trends and available data, and wherein the digital twin is updated using the predicted future data points.
